(19) United States
(12) Patent Application Publication
(10) Pub. No.: US 2020/0029127 A1
(43) Pub. Date: Jan. 23, 2020

(54) METHODS AND SYSTEMS FOR CONTENT NOTIFICATIONS

(71) Applicant: COMCAST CABLE COMMUNICATIONS, LLC, Philadelphia, PA (US)

(72) Inventor: Edward Garbacz, Harleysville, PA (US)

(21) Appl. No.: 16/041,400

(22) Filed: Jul. 20, 2018

(51) Int. Cl. H04N 21/472; H04N 21/262; H04N 21/25; H04N 21/488

(52) U.S. Cl. CPC H04N 21/472; H04N 21/4882; H04N 21/251; H04N 21/26241

(57) ABSTRACT

Systems and methods are described for providing a notification are described. A computing device may determine a content portion is being displayed. The computing device may provide a notification that indicates an entity of the content portion.

### BACKGROUND

Content, such as video content, may be displayed to viewers, and commercial breaks may be part of the content. During the commercial breaks, viewers often leave the location where the content is displayed (e.g., a living room) to perform other tasks (e.g., prepare food, use the restroom). If the viewer leaves the display location, the viewer usually desires to return to the display location before the end of the commercial break to avoid missing content. However, the viewer does not know when to return to the display location to ensure no content is missed. These and other shortcomings are addressed by the methods and systems described herein.

### SUMMARY

It is to be understood that both the following general description and the following detailed description are exemplary and explanatory only and are not restrictive. Provided are methods and systems for providing a notification related to the end of a content portion. Content, such as a television program, may be provided/displayed to a user. A portion of the content may be one or more commercial breaks, and each commercial break may have one or more associated entities or sponsors (e.g., advertisers). Each commercial break may have associated metadata that indicates the entity/sponsor/advertiser of the commercial break. Further, the metadata may indicate a length of time of each commercial break and/or an amount of time remaining in the commercial break. The metadata may be analyzed (e.g., by a computing device) to determine the entity/sponsor/advertiser for each of the commercial breaks, as well as the length of time remaining in the commercial break. At a time prior to the end of the commercial break, a notification may be provided (e.g., by the computing device or another device) to the user that indicates the one or more associated entities of a particular commercial break along with an indication of time remaining in the particular commercial break. Thirty seconds before the end of the commercial break, the computing device may send the notification to a user device to inform the user that the commercial break is about to end, as well as provide information on the entities of the commercial break. A primary entity of a commercial break may be determined, and the notification may indicate only the primary entity along with an indication of time remaining in the commercial break.

Additional advantages will be set forth in part in the description which follows or can be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, show examples and together with the description, serve to explain the principles of the methods and systems:

FIG. 1 is an example of a system;

FIG. 2 is an example diagram of content;

FIG. 3 is a flowchart of an example method;

FIG. 4 is a flowchart of an example method;

FIG. 5 is a flowchart of an example method; and

FIG. 6 is a block diagram of an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular examples only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another example includes from the one particular value and/or to the other particular value. Similarly, when values are expressed as approximations, by use of the antecedent “about,” it will be understood that the particular value forms another example. It will be further understood that the endpoints of each of the ranges are significant both in relation to the other endpoint, and independently of the other endpoint.

“Optional” or “optionally” means that the subsequently described event or circumstance may or may not occur, and that the description includes examples where said event or circumstance occurs and examples where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal example. “Such as” is not used in a restrictive sense, but for explanatory purposes.

Described herein are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all examples of this application including, but not limited to, steps in described methods. Thus, if there are a variety of additional steps that may be performed it is understood that each of these additional steps may be performed with any specific example or combination of examples of the described methods.

The present methods and systems may be understood more readily by reference to the following description of preferred examples and the examples included therein and to the Figures and their previous and following description.

As will be appreciated by one skilled in the art, the methods and systems may take the form of an entirely hardware example, an entirely software example, or an example combining software and hardware example. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described below with reference to block diagrams and flowcharts of methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowcharts support combinations of means for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Content items (which may also be referred to as “content,” “content data,” “content information,” “content asset,” “multimedia asset data file,” or simply “data” or “information”) may be any information or data that may be licensed to one or more individuals (or other entities, such as business or group). Content may include electronic representations of video, audio, text and/or graphics, which may include but is not limited to electronic representations of videos, movies, or other multimedia, which may include but is not limited to data files adhering to MPEG2, MPEG, MPEG4 UHD, HDR, 4 k, Adobe® Flash® Video (.FLV) format or some other video file format whether such format is presently known or developed in the future. The content items described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP), Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv). Adobe® Photoshop® (.PSD) format or some other format for electronically storing text, graphics and/or other information whether such format is presently known or developed in the future. Content items may include any combination of the above-described examples.

Consuming content or the consumption of content, which may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

Note that an example may refer to a given entity performing some action. It should be understood that this language may in some cases mean that a system (e.g., a computer) owned and/or controlled by the given entity is actually performing the action.

A notification may be presented to a user based on timing of content. A user may receive a notification that a commercial break is over, and a watched program is about to resume. The user may step away from a display device during a commercial break, and the user may receive a notification on the user's cellphone that indicates the commercial break is about to end and/or a time remaining in the commercial break. The notification may indicate an entity of the notification. The entity of the notification may be a sponsor associated with the commercial break that the user missed.

A notification may identify and/or indicate that the content that the user was viewing will be returning in an indicated amount of time, (e.g., 30 seconds, one minute, etc.). A notification may identify and/or indicate an entity, a sponsor or another entity associated with the notification. A notification may include the message: “Your show will be returning in 30 seconds. This notification has been brought to you by: [List of Names]” where the List of Names includes one, some, or all the entities of the commercial break or a different entity altogether.

A notification may be provided for the commercial break or for each commercial shown during the commercial break. A notification may be a portion of text, a picture, and/or logo. A notification may include the message: “[Entity] is selling the best widgets in town. Your show will be resuming shortly” where [Entity] is the entity's name. This notification may be followed by notifications for each commercial during the commercial break. One or more notifications in a series of notifications, e.g., the last notification in the series, may identify when the content the user is viewing is estimated to resume, e.g., 30 seconds. The notification could include the message: “Your show will be returning in 30 seconds. [Entity or Sponsor] is selling the best widgets in town.”

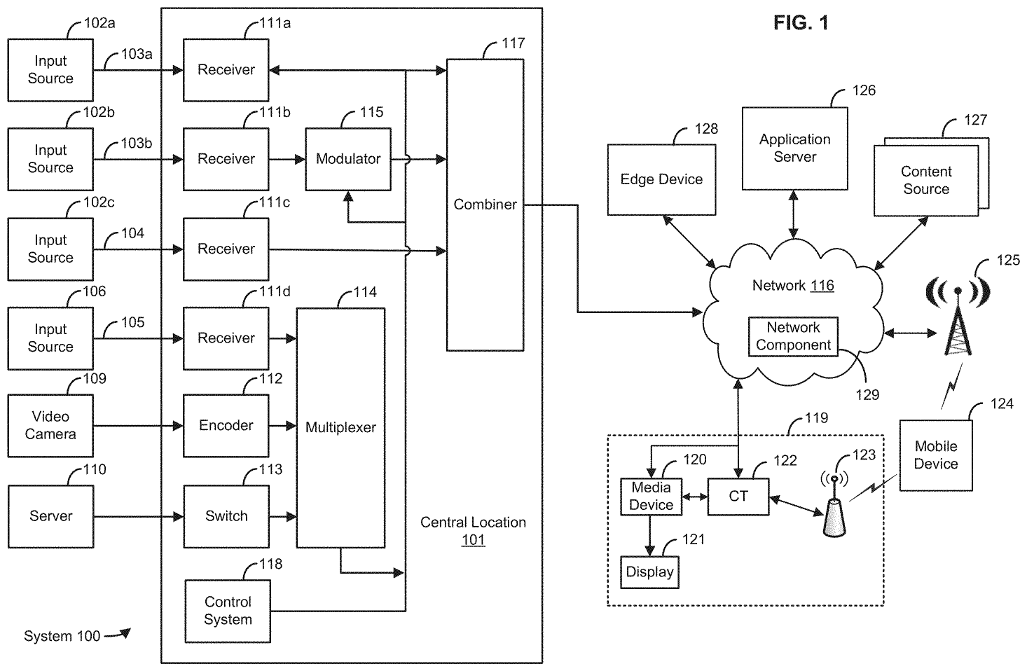

FIG. 1 shows an example of a system 100. Those skilled in the art will appreciate that the methods described herein may be used in systems that employ both digital and analog equipment. One skilled in the art will appreciate that provided herein is a functional description and that the respective functions may be performed by software, hardware, or a combination of software and hardware.

The system 100 may have a central location 101 (e.g., a headend), which may receive content (e.g., data, input programming, and the like) from multiple sources. The central location 101 may combine the content from the various sources and may distribute the content to user (e.g., subscriber) locations (e.g., location 119) via a network 116 (e.g., content distribution and/or access system).

The central location 101 may receive content from a variety of sources 102a, 102b, and 102c. The content may be sent from the source to the central location 101 via a variety of transmission paths, including wireless (e.g., satellite paths 103a, 103b) and terrestrial path 104. The central location 101 may also receive content from a direct feed source 106 via a direct line 105. Other input sources may be capture devices such as a video camera 109 or a server 110. The signals provided by the content sources may include a single content item, a portion of a content item (e.g., content fragment, content portion, content section), a content stream, a multiplex that includes several content items, and/or the like.

The central location 101 may be one or a plurality of receivers 111a, 111b, 111c, 111d that are each associated with an input source. MPEG encoders such as encoder 112, are included for encoding local content or a video camera 109 feed. A switch 113 may provide access to server 110, which may be a Pay-Per-View server, a data server, an internet router, a network system, a phone system, and the like. Some signals may require additional processing, such as signal multiplexing, prior to being modulated. Such multiplexing may be performed by multiplexer (mux) 114.

The central location 101 may be one or a plurality of modulators 115 for interfacing to a network 116. The modulators 115 may convert the received content into a modulated output signal suitable for transmission over the network 116. The output signals from the modulators 115 may be combined, using equipment such as a combiner 117, for input into the network 116.

The network 116 may be a content delivery network, a content access network, and/or the like. The network 116 may be configured to provide content from a variety of sources using a variety of network paths, protocols, devices, and/or the like. The content delivery network and/or content access network may be managed (e.g., deployed, serviced) by a content provider, a service provider, and/or the like.

A control system 118 may permit a system operator to control and monitor the functions and performance of system 100. The control system 118 may interface, monitor, and/or control a variety of functions, including, but not limited to, the channel lineup for the television system, billing for each user, conditional access for content distributed to users, and the like. The control system 118 may provide input to the modulators 115 for setting operating parameters, such as system specific MPEG table packet organization or conditional access information. The control system 118 may be located at the central location 101 or at a remote location.

The network 116 may distribute signals from the central location 101 to user locations, such as a user location 119. The network 116 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

A multitude of users may be connected to the network 116 at one or more of the user locations. At the user location 119, a media device 120 may demodulate and/or decode, if needed, the signals for display on a display device 121, such as on a television set (TV) or a computer monitor. The media device 120 may be a demodulator, decoder, frequency tuner, and/or the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may be a set-top box, a digital streaming device, a gaming device, a media storage device, a digital recording device, a combination thereof, and/or the like. The media device 120 may have one or more applications, such as content viewers, social media applications, news applications, gaming applications, content stores, electronic program guides, and/or the like. Those skilled in the art will appreciate that the signal may be demodulated and/or decoded in a variety of equipment, including the communication terminal 122, a computer, a TV, a monitor, or a satellite dish.

The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), and/or the like. The communication terminal 122 may be configured for communication with the network 116 via a variety of protocols, such as internet protocol, transmission control protocol, file transfer protocol, session initiation protocol, voice over internet protocol, and/or the like. For a cable network, the communication terminal 122 may be configured to provide network access via a variety of communication protocols and standards, such as Data Over Cable Service Interface Specification (DOCSIS).

The user location 119 may be a first access point 123, such as a wireless access point. The first access point 123 may be configured to provide one or more wireless networks in at least a portion of the user location 119. The first access point 123 may be configured to provide access to the network 116 to devices configured with a compatible wireless radio, such as a mobile device 124, the media device 120, the display device 121, or other computing devices (e.g., laptops, sensor devices, security devices). The first access point 123 may provide a user managed network (e.g., local area network), a service provider managed network (e.g., public network for users of the service provider), and/or the like. It should be noted that in some configurations, some or all of the first access point 123, the communication terminal 122, the media device 120, and the display device 121 may be implemented as a single device.

The user location 119 may not be fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 may communicate with a variety of access points (e.g., at different times and locations or simultaneously if within range of multiple access points). The mobile device 124 may communicate with a second access point 125. The second access point 125 may be a cell tower, a wireless hotspot, another mobile device, and/or other remote access point. The second access point 125 may be within range of the user location 119 or remote from the user location 119. The second access point 125 may be located along a travel route, within a business or residence, or other useful locations (e.g., travel stop, city center, park).

The system 100 may be an application server 126. The application server 126 may provide services related to applications. The application server 126 may have an application store. The application store may be configured to allow users to purchase, download, install, upgrade, and/or otherwise manage applications. The application server 126 may be configured to allow users to download applications to a device, such as the mobile device 124, communications terminal 122, the media device 120, the display device 121, and/or the like. The application server 126 may run one or more application services to provide data, handle requests, and/or otherwise facilitate operation of applications for the user.

The system 100 may have one or more content sources 127. The content source 127 may be configured to provide content (e.g., video, audio, games, applications, data) to the user. The content source 127 may be configured to provide streaming media, such as on-demand content (e.g., video on-demand), content recordings, and/or the like. The content source 127 may be managed by third party content providers, service providers, online content providers, over-the-top content providers, and/or the like. The content may be provided via a subscription, by individual item purchase or rental, and/or the like. The content source 127 may be configured to provide the content via a packet switched network path, such as via an internee protocol (IP) based connection. The content may be accessed by users via applications, such as mobile applications, television applications, set-top box applications, gaming device applications, and/or the like. An application may be a custom application (e.g., by content provider, for a specific device), a general content browser (e.g., web browser), an electronic program guide, and/or the like.

The system 100 may be an edge device 128. The edge device 128 may be configured to provide content, services, and/or the like to the user location 119. The edge device 128 may be one of a plurality of edge devices distributed across the network 116. The edge device 128 may be located in a region proximate to the user location 119. A request for content from the user may be directed to the edge device 128 (e.g., due to the location of the edge device and/or network conditions). The edge device 128 may be configured to package content for delivery to the user (e.g., in a specific format requested by a user device), provide the user a manifest file (e.g., or other index file describing portions of the content), provide streaming content (e.g., unicast, multicast), provide a file transfer, and/or the like. The edge device 128 may cache or otherwise store content (e.g., frequently requested content) to enable faster delivery of content to users.

The network 116 may be a network component 129. The network component 129 may be any device, module, and/or the like communicatively coupled to the network 116. The network component 129 may also be a router, a switch, a splitter, a packager, a gateway, a encoder, a storage device, a multiplexer, a network access location (e.g., tap), physical link, and/or the like.

The methods and systems described may be located within the application server 126, the content source 127, the edge device 128, and/or the media device 120. Any of the application server 126, the content source 127, the edge device 128, and/or the media device 120 may serve as a server relative to a user device, such as the media device 120 and/or the mobile device 124, and provide notifications related to content to the user device. The application server 126, the content source 127, the edge device 128, and/or the media device 120 may determine that content is being displayed/consumed. The content may be video content, such as a television program, having one or more commercials. The content may be displayed on the display 121 and/or the mobile device 124. The application server 126, the content source 127, and/or the edge device 128 may determine that the media device 120 is causing the display of content on the display 121. The application server 126, the content source 127, the edge device 128, and/or the media device 120 may receive a request for specific content (e.g., a television program) that a user desires to watch. Further, the media device 120 may know that the media device 120 is causing the display of content on the display. The application server 126, the content source 127, and/or the edge device 128 may receive a notification from the media device 120 indicating that a user is consuming (e.g., viewing) the content.

The content displayed on display 121 and/or the mobile device 124 may have a plurality of content portions. The content may be video content of television programming with commercials. Some non-limiting examples of a content portion may include one or more scenes of the television programming, one or more commercials (e.g., a commercial break), one or more scenes of a movie, a live sporting event, and so forth.

The application server 126, the content source 127, the edge device 128, and/or the media device 120 may determine a start of a content portion. The content may be associated with metadata that indicates transitions between portions of content (e.g., the end of a content portion, the start of a content portion). The content may have markers that indicate an available ad slot and/or a transition between content (e.g., splice points and/or events as described in the SCTE-35 Standard). The application server 126, the content source 127, the edge device 128, and/or the media device 120 may analyze the metadata of the content to identify the end of a first content portion and the start of a second content portion. A user may be viewing video content that includes several scenes of television programming (e.g., a first content portion). The video content may include metadata that indicates an end of the television programming, as well as a start of a commercial break having several commercials (e.g., the second content portion). Thus, the application server 126, the content source 127, the edge device 128, and/or the media device 120 may analyze the metadata of the content to determine the start and/or end of a content portion.

The application server 126, the content source 127, the edge device 128, and/or the media device 120 may determine one or more sections of a content portion. The content portion may include metadata that indicates one or more sections of the content portion. The content portion may be a commercial break consisting of one or more commercials. Each of the commercials may include metadata that indicates each of the commercials as an individual section within the commercial break (e.g., the content portion). The application server 126, the content source 127 the edge device 128, and/or the media device 120 may analyze the metadata of the content portion to determine the sections of the content portion. A first section of the content portion (e.g., a commercial break) may be a car commercial that is associated with metadata indicating the car commercial as a section of the commercial break, as well as the start and/or end of the car commercial. A second section of the commercial break may be a food commercial that is associated with metadata indicating the food commercial as a section of the commercial break, as well as the start and/or end of the food commercial. The application server 126, the content source 127, the edge device 128, and/or the media device 120 may analyze the metadata of the content portion to determine the individual sections of content (e.g., the car commercial and the food commercial of the commercial break). Thus, the application server 126, the content source 127, the edge device 128, and/or the media device 120 may determine the sections of a content portion.

The application server 126, the content source 127, the edge device 128, and/or the media device 120 may determine an entity for each of the sections of the content portion. The application server 126, the content source 127, the edge device 128, and/or the media device 120 may analyze the content within the sections of the content portion to determine the entity. A section of the content portion may be a commercial that has several logos and/or names of products and/or a manufacturer of the products. The application server 126, the content source 127, the edge device 128, and/or the media device 120 may analyze the content to identify the logos and/or names to determine an entity of the section. The section may be a car commercial with the content of the section comprising a car of a car manufacturer, a name of the car manufacturer, a logo of the car manufacturer, and a catchphrase of the car manufacturer. The application server 126, the content source 127, the edge device 128, and/or the media device 120 may determine, based on the aforementioned content, that the entity of the section of content is the car manufacturer.

The application server 126, the content source 127, the edge device 128, and/or the media device 120 may analyze metadata stored within the content. Each of the sections may be associated with metadata that indicates an entity for the section (e.g., a commercial sponsor). The entity may be a sponsor, an advertiser, an owner, a contributor, and/or a creator that is associated with the content section. The metadata may also indicate the owner of the content (e.g., the company for whom the commercial is for), length of time of the section of content, and so forth. The entity for each section may be a company associated with the respective section. The sections may each be a commercial within a commercial break, and the entity for each of the sections may be the company and/or person presenting the commercial. A first section may be a car commercial, and an entity of the commercial may be a manufacturer of the car in the commercial. The commercial may be a political advertisement, and an entity of the commercial may be a person running for public office that paid for the political advertisement. The application server 126, the content source 127, the edge device 128, and/or the media device 120 may analyze the metadata of the first section (e.g., the car commercial) to determine the entity may be the manufacturer of the car.

An entity of the section may be unrelated to the content presented in the section. The section may be a commercial, and the entity may be unrelated to the commercial. The entity may have agreed to provide the notifications for a fee despite not being in the commercial lineup as another method to interact with the viewer. The application server 126, the content source 127, the edge device 128, and/or the media device 120 may retrieve the entity from a database of a plurality of entity.

Each of the sections may have a different entity. Each of the sections has the same entity. The content portion may be a commercial free section of a television show or live event, and the entity may be the entity that paid for the television show or live event to be commercial free.

The application server 126, the content source 127, the edge device 128, and/or the media device 120 may determine an end time for each of the sections. Metadata may be present within each of the sections of content which indicates a time when the section will end. The application server 126, the content source 127, the edge device 128, and/or the media device 120 may determine an end time for the section based on the content within the section. The section may be a commercial break that is thirty seconds long, and the application server 126, the content source 127, the edge device 128, and/or the media device 120 may determine the end time based on when the section began and the length of time of the section. The application server 126, the content source 127, the edge device 128, and/or the media device 120 may determine a start time for each of the sections.

The application server 126, the content source 127, the edge device 128, and/or the media device 120 may send or transmit, before the end of each section, a notification identifying the entity for each of the sections. The application server 126, the content source 127, and/or the edge device 128 may send the notification to the media device 120 and/or the mobile device 124. The media device 120 may send the notification to the mobile device 124. The application server 126, the content source 127, the edge device 128, and/or the media device 120 may send the notification as a text message to the mobile device 124. The notification may be sent to the user device via a wireless connection (e.g., via the first access point 123 and/or the second access point 125). The notification identifies the entity by providing identifying material of the entity to the user of the user device. The notification may provide a name of the entity, a logo, a catchphrase, a sound, or any information that may identify the entity.

The application server 126, the content source 127, the edge device 128, and/or the media device 120 may determine a primary entity. The primary entity may be a sponsor of an entire portion of content. The primary entity may be determined based on one or more factors. The primary entity may be determined based on a price paid by the entity, a relationship between the primary entity and a content portion, a relationship between the primary entity and a content provider, or any factor. The primary entity may be determined from the entities of each of the content sections. The primary entity may be unrelated to the each of the content sections. The portion may be a commercial break having one or more commercials, and the primary entity may be unrelated to the commercials presented during the commercial break. The primary entity may be the content provider or a third party entity.

The application server 126, the content source 127, the edge device 128, and/or the media device 120 may determine a user preference. A device (e.g., the mobile device 124 and/or the media device 120 of FIG. 1), may provide the user preference to the application server 126, the content source 127, the edge device 128, and/or the media device 120. The user preference may indicate interests of the user. The preference may indicate activities, sports, and hobbies of the user. The preference may indicate the user is a sports fan, and the application server 126, the content source 127, the edge device 128, and/or the media device 120 may determine the user would prefer entities related to sports. The preference may indicate the demographics of the user such as age, location, family members, and the like. The application server 126, the content source 127, the edge device 128, and/or the media device 120 may determine the user recently had a child, and determine the user would prefer entities related to childcare items. The preference may indicate brands the user prefers such as the user's favorite car company, beverage company, sports team, artist, and the like. The preference may indicate brands or activities that a user is not interested in.

The application server 126, the content source 127, the edge device 128, and/or the media device 120 may automatically determine the user preference. The user preference may be determined based on the actions of the user. If the user regularly watches sporting events, the application server 126, the content source 127, the edge device 128, and/or the media device 120 may determine the user prefers sports. The user may never watch sports content, and the computing device may determine the user does not prefer sports.

The application server 126, the content source 127, the edge device 128, and/or the media device 120 may determine an entity or sponsor based on the user preference. The entity may be determined from a list of entities based on the user preference. The user preference may indicate the user prefers sports so the computing device may determine the user would prefer an entity that is related to sports, and the application server 126, the content source 127, the edge device 128, and/or the media device 120 determines an entity that is sports related from a list of entities. The user preference may indicate the favorite brands of the user, and the application server 126, the content source 127, the edge device 128, and/or the media device 120 uses this information to determine an entity related to one of the favorite brands of the user.

The notification may include information indicating the amount of time before the section ends. The notification may indicate that there is thirty seconds left before the end of the section of content. The section may be a commercial, and the notification indicates the time remaining in the commercial. The notification includes the amount of time before another section and/or content portion starts. The section may be a commercial and the notification may indicate that there is thirty seconds remaining in the commercial, while also indicating that there is one minute left before the next content portion (e.g., of a television show, a live event) starts.

The application server 126, the content source 127, and/or the edge device 128 may determine an account associated with the media device 120 and/or the mobile device 124. The media device 120 and/or the mobile device 124 may provide account information to the application server 126, the content source 127, and/or the edge device 128. The account may be configured to receive content notifications. The account holder may indicate the desire to receive notifications to the media device 120 and/or the mobile device 124. The account holder or user may request to receive notifications at the media device 120 and/or the mobile device 124. The request to receive notifications includes a device identifier in order for the application server 126, the content source 127, and/or the edge device 128 to determine where the notifications should be sent.

The application server 126, the content source 127, the edge device 128, and/or the media device 120 may determine the location of the mobile device 124. The application server 126, the content source 127, the edge device 128, and/or the media device 120 may use UPS, signal triangulation, signal strength, or any suitable method for determining the location of the mobile device 124. The application server 126, the content source 127, the edge device 128, and/or the media device 120 may determine the mobile device 124 is at the user location 119. The user location 119 may be the household of the user, and the application server 126, the content source 127, the edge device 128, and/or the media device 120 may determine the mobile device 124 is within the household. The application server 126, the content source 127, the edge device 128, and/or the media device 120 may determine the mobile device 124 is located away from the media device 120 and/or the display 121. The media device 120 and/or the display 121 may be located in the living room of the user's household, and the mobile device 124 may be located in the kitchen of the user's household because the user left the living room to grab a snack. The application server 126, the content source 127, the edge device 128, and/or the media device 120 may determine the mobile device 124 is outside of the user location 119. The user may have left the user location 119 with the mobile device 124 in order to run errands. The mobile device 124 provides the location of the mobile device 124 to the application server 126, the content source 127, the edge device 128, and/or the media device 120. The mobile device 124 may send a signal to the application server 126, the content source 127, the edge device 128, and/or the media device 120 that includes data location for the mobile device 124.

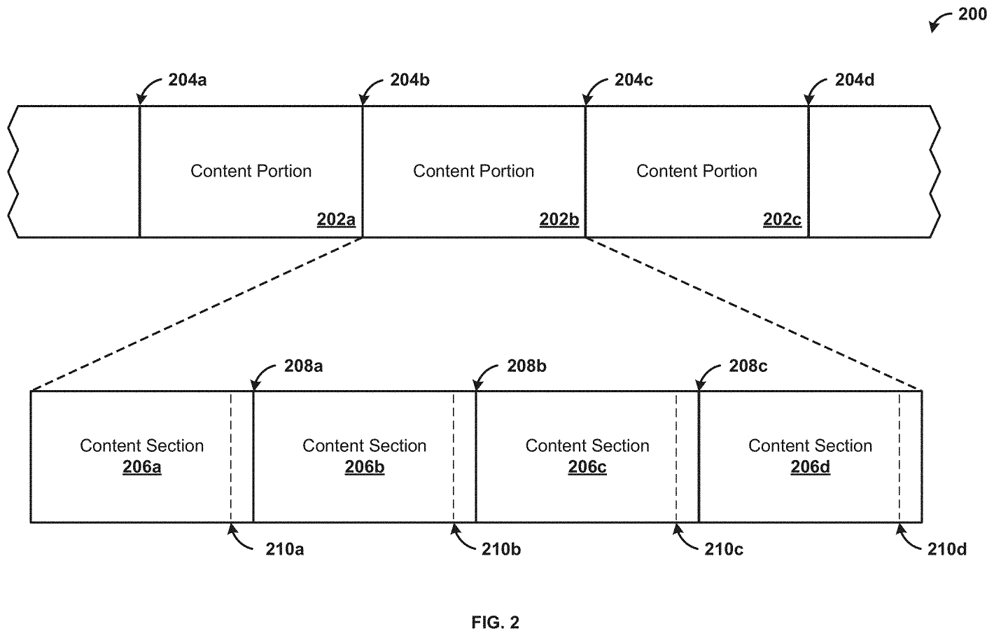

FIG. 2 shows an example of content 200 provided by a content provider. The content 200 is video content presented to a viewer. The content 200 may be video content of television programming with commercials. The content 200 may be a live event (e.g., a sporting event, a concert, etc.) or a movie comprising scenes. The content 200 may have a plurality of content portions 202. As shown, the content 200 has content portions 202a, 202b, and 202c. The content 200 may be displayed in a continuous manner to a viewer. The content portions 202 are displayed in order from left to right such that the content portion 202a may be presented at a time before the content portion 202b and so forth. When the content portion 202a ends, the content portion 202b automatically starts. Some non-limiting examples of a content portion may include one or more scenes of the television programming, one or more commercials (e.g., a commercial break), one or more scenes of a movie, a live sporting event, and so forth. While the content portions 202 are shown as being equal, a person skilled in the art would appreciate the content portions 202 may each be different lengths and consist of different content.

The content portions 202 may each have a transition 204. The transition 204 indicates a start time of one content portion 202, and/or an end time of another content portion 202. The content portion 202a has a transition 204a and a transition 204b. The transition 204a indicates the start time of the content portion 202a while the transition 204b indicates the end time of the content portion 202a. Further, the transition 204b also indicates the start time of the content portion 202b. Thus, the content portion 202b has a start time that coincides with the end time of the content portion 202a.

The content portion 202a may be a portion of a television show, and the transition 204b indicates when the portion of the television show ends. Additionally, the content portion 202b may be a commercial break. Stated differently, the content portion 202b may be an advertisement portion. Accordingly, the transition 204b further indicates the start of the commercial break (e.g., the content portion 202b). Thus, the transition 204b may indicate when the portion of the television show (e.g., the content portion 202a) may end, as well as when the commercial break (e.g., the content portion 202b) may start. The content portion 202c may be a second portion of the television show. Accordingly, the transition 204c indicates the end of the commercial break (e.g., the content portion 202b), as well as indicates the start of the second portion of the television show (e.g., the content portion 202c). In this manner, the transitions 204 indicate when the content portions 202 change.

The content 200 may also have metadata that indicates times at which the content portions 202 start and/or end. The metadata may include information related to the transition 204b. The metadata may indicate a specific point in time that the transition 204b occurs such as at 12:02:25 PM. The time of the transition 204b may be in relation to the content 200. The time of the transition 204b may be 5 minutes and 30 seconds after the transition 204a (e.g., the start of the content portion 202a). The time of the transition 204b may be 4 minutes and 15 seconds before the transition 204c (e.g., the start of the content portion 202c).

The metadata may also include information indicating what the next content portion 202 will be. That is, the metadata may indicate the content of the content portions 202. The content portion 202b may be associated with metadata indicating what will be shown to the viewer during presentation of the content portion 202c. The transitions 204 may include metadata that indicates the content of the content portions 202. The transition 204b may include metadata that indicates the content of the content portion 202a (e.g., a portion of a television show), as well as the content of the content portion 202b (e.g., a commercial break, an advertisement portion, etc.).

The content portions 202 may be content sections 206. The content portion 202b consist of content sections 206a, 206b, 206c, and 206d. The content portion 202b may be a television show and the content sections 206 may be scenes of the television show being presented to a viewer. The content portion 202b may be an advertisement portion (e.g., a commercial break), and the content sections 206 may be individual advertisements within the advertisement portion (e.g., commercials within the commercial break). While only the content portion 202b is shown as comprising the content sections 206 for ease of explanation, a person skilled in the art would appreciate that any of the content portions 202 may include the content sections 206. Further, while the content sections 206 are shown as being equal (e.g., equal length of time, content size, etc.), a person skilled in the art would appreciate the content sections 206 may each be different lengths and consist of different content.

The content sections 206 may each have a transition 208. The transitions 208 indicate the end time of one of the content sections 206 and/or indicates the start of another content section 206. The content section 206a ends at transition 208a, which is also the time that the content section 206b starts. The content section 206a may be a first commercial of a commercial break. The content section 206b may be a second commercial of the commercial break. Thus, the transition 208a indicates the end of the first commercial (e.g., the content section 206a), and the start of the second commercial (e.g., the content section 206b). The content section 206c may be a first scene of a television show. The content section 206d may be a second scene of the television show. Thus, the transition 208c indicates the end of the first scene of the television show (e.g., the content section 206c), and the start of the second scene of the television show (e.g., the content section 206d).

The content sections 206 may have metadata that indicates times at which the content sections 206 start and/or end. The metadata may include information related to the transition 208b. The metadata may indicate a specific point in time that the transition 208b occurs such as at 1:20:59 AM. The time of the transition 208b may be in relation to the content sections 206. The time of the transition 208b may be 2 minutes and 45 seconds after the transition 208a (e.g., the start of the content section 206a). The time of the transition 208b may be 10 minutes and 5 seconds before the transition 208c (e.g., the start of the content sections 206d).

The metadata may also include information indicating the content of the content sections 206. The metadata may indicate what the next content section 206 will be. The content section 206b may be associated with metadata indicating what content will be shown to the viewer during presentation of the content section 206c. The transitions 208 may include metadata that indicates the content of the content section 206. The transition 208a may include metadata that indicates the content of the content section 206a (e.g., a first commercial of a commercial break), as well as the content of the content section 206b (e.g., a second commercial of the commercial break).

The content sections 206 may also have metadata that indicates a time 210 prior to the end and/or start of the content sections 206. Each of the content sections 206 may include a respective time 210 (e.g., the content section 206a has a time 210a, the content section 206b has a time 210b, and so forth). The times 210 may indicate an imminent ending of one of the content sections 206. The time 210a indicates that the content section 206a will end soon. The time 210a may be a predetermined length of time or time period before the end of the content section 206a (e.g., the transition 208a), such as 30 seconds before the end of the content section 206a. The times 210 may indicate an imminent end of a content portion 202. The time 210d may indicate that the content section 206d and/or the content portion 202b may be ending soon. The times 210a, 210b, 210c, and/or 210d may also indicate the length of time left in the content portion 202b (e.g., the time until the end of the content section 206d). Thus, the times 210 may indicate the end of a content section 206 and/or the end of a content portion 202.

The times 210 may indicate an imminent start of one of the content sections 206. The time 210a indicates that the content section 206b will start soon. The time 210a may he a predetermined length of time or time period before the start of the content section 206b (e.g., the transition 208a), such as 30 seconds before the start of the content section 206b. The times 210 may indicate an imminent start of a content portion 202. The time 210d may indicate that the content portion 202c may be starting soon. The times 210a, 210b, 210c, and/or 210d may also indicate the length of time left in the content portion 202b (e.g., the time until the start of the content portion 202c). Thus, the times 210 may indicate the start of a content section 206 and/or the start of a content portion 202. While the times 210 are shown at the same time before the end and/or start of a content section 206 for ease of explanation, a person skilled in the art would appreciate that the times 210 for each section may be different.

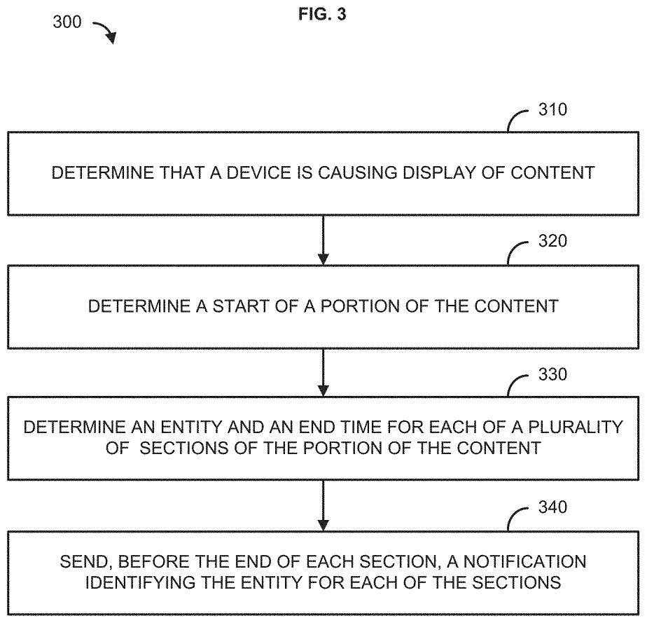

FIG. 3 is a flowchart of an example method 300. In step 310, a device causing display (e.g., the display 121 of FIG. 1) of content (e.g., the content 200 of FIG. 2) may be determined by a computing device (e.g., the application server 126, the content source 127, and/or the edge device 128 of FIG. 1). The computing device may determine that the display 121 is displaying content from the media device 120. The computing device may receive a signal from the media device 120 indicating that the media device 120 is sending content to the display 121. The display 121 may send a signal to the computing device and/or the media device 120 that indicates the display 121 is displaying content. The media device 120 may request, from the computing device, content for display. Accordingly, the computing device may determine that the content is being displayed based on the request from the media device 120. The content may be pre-recorded video, live video, a combination thereof, and the like.

In step 320, a start of a portion (e.g., a content portion 202 of FIG. 2) of the content may be determined by a computing device (e.g., the application server 126, the content source 127, the edge device 128, and/or the media device 120). The computing device may analyze the content (e.g., the content 200 of FIG. 2) to determine the start of the content portion (e.g., the content portions 202 of FIG. 2). The computing device may identify a transition (e.g., the transitions 204 of FIG. 2) between the content portions to determine that one content portion ended and another content portion started. The computing device may determine a length of time of a previous content portion, and based on the length of time, determine when the previous content portion will end and the content portion will begin. The content portion may be an advertisement portion that consists of a plurality of advertisements (e.g., a commercial break comprising one or more commercials). The content portion may be a television show, a movie, a live event, and so forth. Sections (e.g., content sections 206 of FIG. 2) of the portion of the content may be determined by a computing device (e.g., the application server 126, the content source 127, the edge device 128, and/or the media device 120). The computing device may analyze the content portion (e.g., the content portion 202 of FIG. 2) to determine content sections (e.g., the content sections 206 of FIG. 2) of the content portion. The computing device may identify transitions (e.g., the transitions 208 of FIG. 2) between the content sections to determine the different content sections. The computing device may determine the content sections based on metadata embedded within the content that indicates the content sections. The sections of the content portion may be individual advertisement within an advertisement portion (e.g., commercials within a commercial break). The sections may also be scenes of a television show or a movie. The sections of the content portion may also be pauses in action of a live event (e.g., break times during a sporting event, pauses during songs of a concert, etc.).

In step 330, an entity for each of the sections of the content portion may be determined by a computing device (e.g., the application server 126, the content source 127, the edge device 128, and/or the media device 120). The computing device may analyze the content and/or the metadata of the content sections to determine an entity of the content section. The entity may be a sponsor, an advertiser, an owner, a contributor, and/or a creator that is associated with the content section. The entity for each section of the content portion may be a company associated with the respective section of the content portion. The sections of the content portion may each be an advertisement or a commercial, and the entity for each of the sections of the content portion may be the company that paid for the advertisement or commercial that is being displayed.

The content section may be a car commercial. The computing device may analyze the content section (e.g., the car commercial) to determine the manufacturer of the car presented in the commercial. The computing device may determine that the manufacturer is the entity associated with the content section. The entity of the section of the content portion may be unrelated to the content presented in the section of the content portion. The section of the content portion may be a commercial, and the entity may be unrelated to the commercial The entity may have paid to be the entity for an entire commercial break, and not just for a single commercial. Thus, the entity is the sponsor for each of the commercials or is associated with each of the commercials, even though the entity may be unrelated to the commercial being displayed. The content portion may be a commercial free section of a television show or live event, and the entity paid for the television show or live event to be commercial free. Each of the sections may have a different entity. Each of the sections may have the same entity.

An end time for each of the sections of the content portion (e.g., the transitions 208 of content sections 206 of FIG. 2) may be determined by a computing device (e.g., the application server 126, the content source 127, the edge device 128, and/or the media device 120). The computing device may analyze the content to determine when the content sections transitions to another content section (e.g., the transitions 208 of FIG. 2), and determine the content section ends at the transition. Metadata may be present within each of the content sections that indicates a time when the section will end. An end time for the section may be determined based on the content within the section. The section may be a commercial break that is thirty seconds long, and the end time may be based on when the section began and the length of time of the section. A start time for each of the sections (e.g., transition 208 of content sections 206 of FIG. 2) may be determined. While step 350 is described as determining a start and/or end of a content section, a person skilled in the art would appreciate the start and/or end of a content section may coincide with the start and/or end of a content portion 202 as shown in FIG. 2.

In step 340, before the end of each section, a notification identifying the entity for each of the sections may be transmitted or sent by the computing device (e.g., the application server 126, the content source 127, the edge device 128, and/or the media device 120). The computing device may analyze the content section (e.g., the content sections 206 of FIG. 2) to determine a time before the content section ends. The computing device may identify the times (e.g., the times 210 of FIG. 2) before the content sections end. The computing device may determine the end of the content sections based on metadata embedded within the content that indicates the end of the content sections. When the time before the end of a content section occurs, the computing device may send a notification identifying the entity of the section to a user device (e.g., the mobile deice 124). The notification may be sent to the user device via a wireless connection (e.g., via the first access point 123 and/or the second access point 125). Each of the sections may be a commercial during a commercial break, and the notification identifies a sponsor or an entity for each of the commercials during the commercial break.

The notification may be sent at the time 210 of FIG. 2 before the commercial break ends. The computing device sends a notification to a user device that notifies a user of the user device that the content section may be ending. The notification may identify the entity or the sponsor of the content section. The notification may include the amount of time left before the section ends. The notification may indicate that there are 30 seconds left in the commercial. The notification may be a text message sent to the user device or an electronic message capable of notifying the user of the user device that the content section may be ending and/or the entity or the sponsor of the content section. The notification may be presented through an application running on the user device.

The notification may identify the entity by providing identifying material of the entity to the user of the user device. The notification may provide a name of the entity, a logo, a catchphrase, a sound, or any information that may identify the entity. The notification may be a text message sent to the mobile device 124 that includes the name of the entity.

The notification may include information indicating the amount of time before the section ends. The notification may indicate that there is thirty seconds left before the end of the content. The section may be a commercial, and the notification may indicate the time remaining in the commercial. The notification may include the amount of time before another section and/or content portion starts. The section may be a commercial and the notification may indicate that there is thirty seconds remaining in the commercial, while also indicating that there is one minute left before the next content portion (e.g., of a television show, a live event) starts.

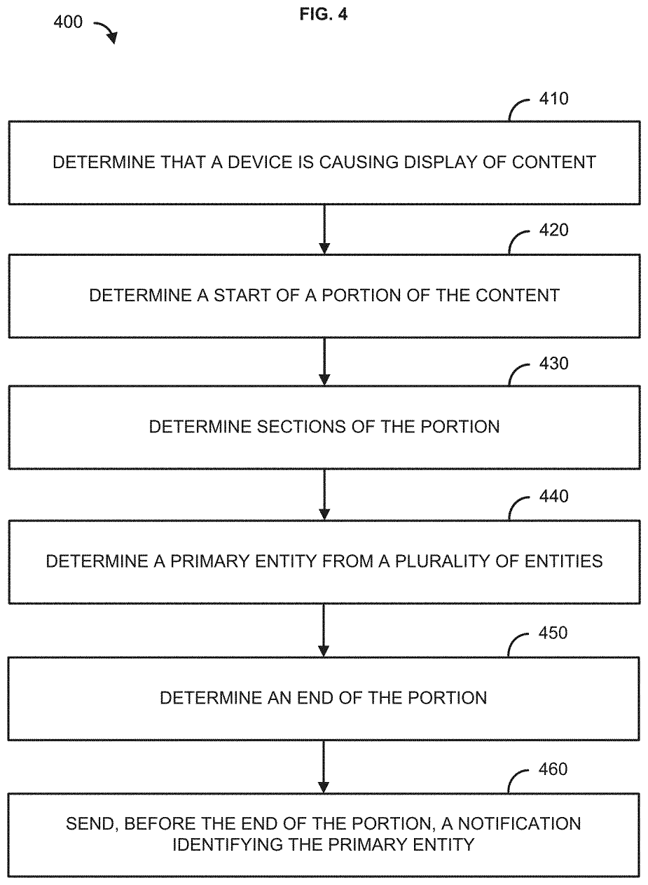

FIG. 4 is a flowchart of an example method 400. At step 410, a device causing display (e.g., the display 121 of FIG. 1) of content (e.g., the content 200 of FIG. 2) may be determined by a computing device (e.g., the application server 126, the content source 127, and/or the edge device 128 of FIG. 1). The server may determine that the display 121 is displaying content from the media device 120. The computing device may receive a signal from the media device 120 indicating that the media device 120 is sending content to the display 121. The display 121 may send a signal to the computing device and/or the media device 120 that indicates the display 121 is displaying content. The media device 120 may request, from the computing device, content for display. Accordingly, the computing device may determine that the content is being displayed based on the request from the media device 120. The content may be pre-recorded video, live video, a combination thereof, and the like.

In step 420, a start of a portion (e.g., a content portion 202 of FIG. 2) of the content may be determined by a computing device (e.g. the application server 126, the content source 127, the edge device 128, and/or the media device 120). The computing device may analyze the content (e.g., the content 200 of FIG. 2) to determine the start of the content portion (e.g., the content portions 202 of FIG. 2). The computing device may identify a transition (e.g., the transitions 204 of FIG. 2) between the content portions to determine that one content portion ended and another content portion started. The computing device may determine a length of time of a previous content portion, and based on the length of time, determine when the previous content portion will end and the content portion will begin. The content portion may be an advertisement portion comprising one or more advertisements (e.g., a commercial break comprising one or more commercials). The content portion may be a television show, a movie, a live event, and so forth.

In step 430, sections (e.g., content sections 206 of FIG. 2) of the portion of the content may be determined by a computing device (e.g., the application server 126, the content source 127, the edge device 128, and/or the media device 120). The computing device may analyze the content portion (e.g., the content portion 202 of FIG. 2) to determine content sections (e.g., the content sections 206 of FIG. 2) of the content portion. The computing device may identify transitions (e.g., the transitions 208 of FIG. 2) between the content sections to determine the different content sections. The computing device may determine the content sections based on metadata embedded within the content that indicates the content sections. The sections of the content portion may be individual advertisements within an advertisement portion (e.g., commercials within a commercial break). The sections may also be scenes of a television show or a movie. The sections of the content portion may also be pauses in action of a live event (e.g., break times during a sporting event, pauses during songs of a concert, etc.).

In step 440, a primary entity is determined (e.g. by the application server 126, the content source 127, and/or the edge device 128). The entity may be a sponsor, an advertiser, an owner, a contributor, and/or a creator that is associated with the content section. The entity for each section of the content portion may be a company associated with the respective section of the content portion. The sections of the content portion may each be a commercial, and the entity for each of the sections of the content portion may be the company and/or sponsor that paid for the commercial that is being displayed. The content portion may be an advertisement portion and each of the sections of the advertisement portion may be an advertisement. The content section may be a car commercial. The computing device may analyze the content section (e.g., the car commercial) to determine the manufacturer of the car presented in the commercial. The computing device may determine that the manufacturer is the entity of the content section. The entity of the section of the content portion may be unrelated to the content presented in the section of the content portion. The section of the content portion may be a commercial, and the entity may be unrelated to the commercial. The entity may have paid to be the sponsor for an entire commercial break, and not just for a single commercial. Thus, the entity may be the sponsor for each of the commercials, even though the entity may be unrelated to the commercial being displayed. The content portion may be a commercial free section of a television show or live event, and the entity paid for the television show or live event to be commercial free. Each of the sections may have a different entity associated with each section, and/or each of the sections may have the same entity associated with each section.

The primary entity may be an entity associated with the entire portion. The primary entity may be determined based on one or more factors. The primary entity may be determined based on a price paid by the entity, a relationship between the entity and a content portion, a relationship between the primary entity and a content provider, or any factor. The primary entity may be determined from the entity of each of the content sections. The primary entity may be unrelated to the each of the content sections. The portion may be an advertisement portion comprising one or more advertisements (e.g., a commercial break having one or more commercials), and the primary entity may be unrelated to the advertisements (e.g., commercials) presented during the advertisement portion (e.g., the commercial break). The primary entity may be the content provider or a third party entity.

In step 450, an end time of the portion (e.g., transition 204 of content portions 202 of FIG. 2) may be determined by a computing device (e.g., the application server 126, the content source 127, the edge device 128, and/or the media device 120). The computing device may analyze the content to determine when the content portion transitions to another content portion (e.g., the transitions 202 of FIG. 2), and determine the content portion ends at the transition. Metadata may be present within each of the content portions that indicates a time when the portion will end. An end time for the portion may be based on the content within the portion. The portion may be an advertisement portion (e.g., a commercial break) that is two minutes long, and the end time may be determined based on when the portion began and the length of time of the portion. While step 460 is described as determining an end of a content portion for ease of explanation, a person skilled in the art would appreciate the end of a portion may coincide with the start of another content portion such that the computing device may also determine a start time of a content portion.

In step 460, before the end of the portion, a notification identifying the primary entity is sent (e.g., the application server 126, the content source 127, the edge device 128, and/or the media device 120). The computing device may analyze the content portion (e.g., the content portions 202 of FIG. 2) to determine a time before the content portion ends. The computing device may identify the times (e.g., the times 210 of FIG. 2) before the content portion ends. The computing device may determine the end of the content portion based on metadata embedded within the content that indicates the end of the content portion. When the time before the end of a content portion occurs, the computing device may send a notification identifying the primary entity of the portion to a user device (e.g., the mobile deice 124). The notification may be sent to the user device via a wireless connection (e.g., via the first access point 123 and/or the second access point 125). The portion may be an advertisement portion (e.g., a commercial break) having one or more advertisements (e.g., commercials), and the notification indicates the primary entity for the advertisement portion (e.g., the commercial break).

The notification may be sent at a time before the content ends. The computing device sends (e.g., transmits) a notification to a user device that notifies the user of the user device that the content portion is ending. The notification may identify the primary entity of the content portion. The notification may include the amount of time left before the portion ends. The notification may indicate that there are 30 seconds left in the commercial break. The notification may be a text message sent to the user device or an electronic message capable of notifying the user of the user device that the content section is ending and/or the primary entity of the content portion. The notification may be presented through an application running on the user device.

The notification may identify the primary entity by providing identifying material of the primary entity to the user of the user device. The notification may provide a name of the primary entity, a logo, a catchphrase, a sound, or any information that may identify the primary entity. The notification may be a text message sent to the user device that includes the name of the primary entity.

The notification may include information indicating the amount of time before the portion ends. The notification may indicate that there is thirty seconds left before the end of the content portion. The content portion may be an advertisement portion (e.g., a commercial break) that has one or more advertisements (e.g., commercials), and the notification indicates the time remaining in the advertisement portion (e.g., the commercial break). The notification may include the amount of time before another section and/or content portion starts. The content portion may be a commercial break and the notification may indicate that there is thirty seconds remaining in the commercial break, while also indicating that there is thirty second left before the next content portion (e.g., of a television show, a live event) starts.

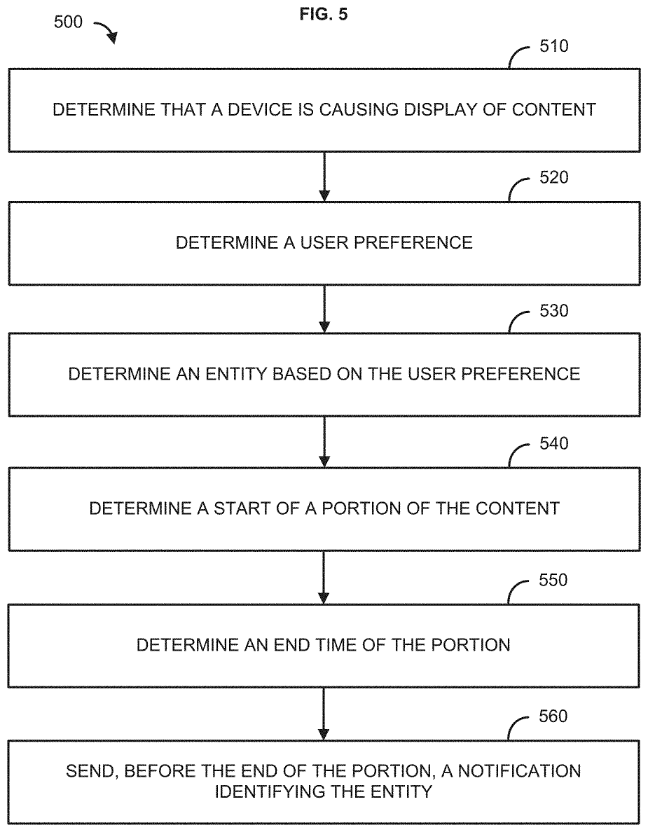

FIG. 5 is a flowchart of an example method 500. At step 510, a device causing display (e.g., the display 121 of FIG. 1) of content (e.g., the content 200 of FIG. 2) may be determined by a computing device (e.g. by the application server 126, the content source 127, and/or the edge device 128). The computing device may determine that the display 121 is displaying content from the media device 120. The computing device may receive a signal from the media device 120 indicating that the media device 120 is sending content to the display 121. The display 121 may send a signal to the computing device and/or the media device 120 that indicates the display 121 is displaying content. The media device 120 may request, from the computing device, content for display. Accordingly, the computing device may determine that the content is being displayed based on the request from the media device 120. The content may be pre-recorded video, live video, a combination thereof, and the like.

In step 520, a user preference may be determined (e.g., by the application server 126, the content source 127, and/or the edge device 128). A device (e.g., the mobile device 124 and/or the media device 120 of FIG. 1), may provide the user preference to the computing device. The user preference may indicate interests of the user. The preference may indicate activities, sports, and hobbies of the user. The preference may indicate the user is a sports fan, and the computing device may determine the user would prefer entities related to sports. The entities may be companies or stores that are associated with sports. The preference may indicate the demographics of the user such as age, location, family members, and the like. The computing device may determine the user recently had a child, and determine the user would prefer entities related to childcare items. The preference may indicate brands the user prefers such as the user's favorite car company, beverage company, sports team, artist, and the like. The preference may indicate brands or activities that a user is not interested in.

The user preference may be automatically determined (e.g., by the application server 126, the content source 127, and/or the edge device 128). The user preference may be determined based on the actions of the user. If the user regularly watches sporting events, the computing device may determine the user prefers sports. The user may never watch sports content, and the computing device may determine the user does not prefer sports.

In step 530, an entity based on the user preference is determined (e.g., by the application server 126, the content source 127, and/or the edge device 128). The entity may be a sponsor, an advertiser, an owner, a contributor, and/or a creator that is associated with the content section. The entity may be determined from a list of entities based on the user preference. The user preference may indicate the user prefers sports so the computing device may determine the user would prefer an entity that is related sports, and the computing device determines an entity that is sports related from a list of entities. The user preference may indicate the favorite brands of the user, and the computing device uses this information to determine an entity related to one of the favorite brands of the user.

In step 540, a start of a portion (e.g., a content portion 202 of FIG. 2) of the content may be determined by a computing device (e.g., the application server 126, the content source 127, the edge device 128, and/or the media device 120). The computing device may analyze the content (e.g., the content 200 of FIG. 2) to determine the start of the content portion (e.g., the content portions 202 of FIG. 2). The computing device may identify a transition (e.g., the transitions 204 of FIG. 2) between the content portions to determine that one content portion ended and another content portion started. The computing device may determine a length of time of a previous content portion, and based on the length of time, determine when the previous content portion will end and the content portion will begin. The content portion may be an advertisement portion (e.g., a commercial break) comprising one or more advertisements (e.g., commercials). The content portion may be a television show, a movie, a live event, and so forth. The portion may be a commercial break comprising one or more commercials. The portion may be a television show, a movie, a live event, and so forth.

In step 550, an end time of the portion (e.g., transition 204 of content portions 202 of FIG. 2) may be determined by a computing device (e.g., the application server 126, the content source 127, the edge device 128, and/or the media device 120). The computing device may analyze the content to determine when the content portion transitions to another content portion (e.g., the transitions 202 of FIG. 2), and determine the content portion ends at the transition. Metadata may be present within each of the content portions that indicates a time when the portion will end. An end time for the portion may be based on the content within the portion. The portion may be an advertisement portion (e.g., a commercial break) that is two minutes long, and the end time may be determined based on when the advertisement portion began and the length of time of the advertisement portion. While step 550 is described as determining an end of a content portion for ease of explanation, a person skilled in the art would appreciate the end of a portion may coincide with the start of another content portion such that the computing device may also determine a start time of a content portion.

In step 560, before the end of the portion, a notification identifying the entity is sent (e.g., the application server 126, the content source 127, the edge device 128, and/or the media device 120). The computing device may analyze the content portion (e.g., the content portions 202 of FIG. 2) to determine a time before the content portion ends. The computing device may identify the times (e.g., the times 210 of FIG. 2) before the content portion ends. The computing device may determine the end of the content portion based on metadata embedded within the content that indicates the end of the content portion. When the time before the end of a content portion occurs, the computing device may send a notification identifying the entity of the portion to a user device (e.g., the mobile deice 124). The notification may be sent to the user device via a wireless connection (e.g., via the first access point 123 and/or the second access point 125). The portion may be an advertisement portion (e.g., a commercial break) comprising one or more advertisements (e.g., commercials), and the notification indicates the entity for the advertisement portion (e.g., the commercial break).

The notification may be sent at a time before the content portion ends. The computing device sends a notification to a user device that notifies the user of the user device that the content portion is ending. The notification may identify the entity associated with the content portion. The notification may include the amount of time left before the portion ends. The notification may indicate that there are 30 seconds left in the commercial break. The notification may be a text message sent to the user device or an electronic message capable of notifying the user of the user device that the content section is ending and/or the entity of the content portion. The notification may be presented through an application running on the user device.

The notification may identify the entity by providing identifying material of the entity to the user of the user device The notification may provide a name of the entity, a logo, a catchphrase, a sound, or any information that may identify the entity. The notification may be a text message sent to the user device that includes the name of the entity.

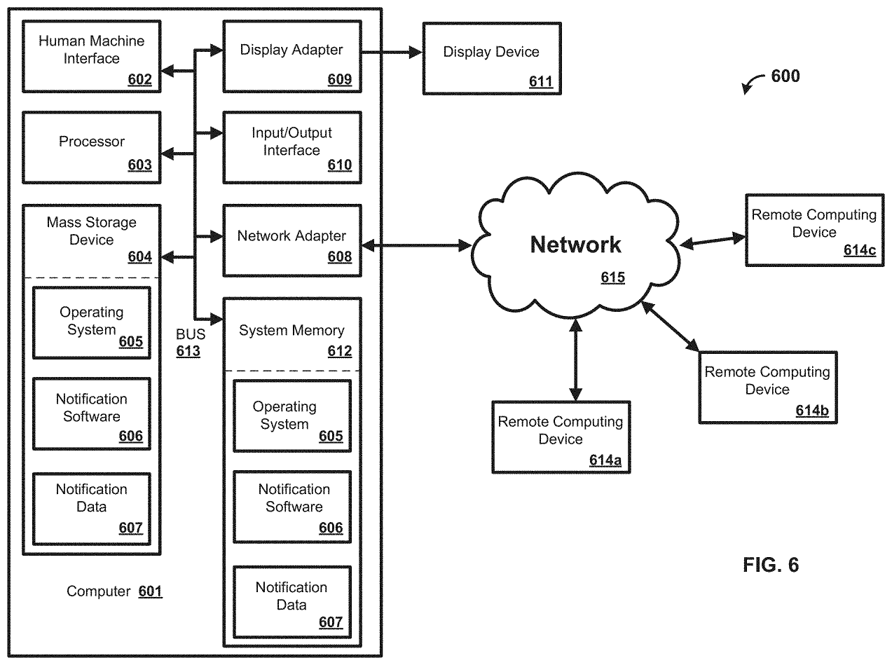

FIG. 6 shows an example of a system 600 comprising a computer 601. The server 110, the application server 126, the content source 127, or the edge device 128 of FIG. 1 may be a computer as shown in FIG. 6. The media device 120 and/or the mobile device 124 of FIG. 1 may be a computer as shown in FIG. 6. Similarly, the methods and systems described may utilize one or more computers to perform one or more functions in one or more locations. FIG. 6 is a block diagram showing an example of an operating environment for performing the described methods. This example of the operating environment is only an example of an operating environment and is not intended to suggest any limitation as to the scope of use or functionality of operating environment architecture. Neither should the operating environment be interpreted as having any dependency or requirement relating to any one or combination of components shown in the example of the operating environment.

The present methods and systems may be operational with numerous other general purpose or special purpose computing system environments or configurations. Examples of well-known computing systems, environments, and/or configurations that may be suitable for use with the systems and methods consist of, but are not limited to, personal computers, server computers, laptop devices, and multiprocessor systems. Additional examples may be set top boxes, programmable consumer electronics, network PCs, minicomputers, mainframe computers, distributed computing environments that consist of any of the above systems or devices, and the like.

The processing of the described methods and systems may be performed by software components. The described systems and methods may be described in the general context of computer-executable instructions, such as program modules, being executed by one or more computers or other devices. Generally, program modules have computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 601. The components of the computer 601 may consist of, but are not limited to, one or more processors 603, a system memory 612, and a system bus 613 that couples various system components including the one or more processors 603 to the system memory 612. The system may utilize parallel computing.

The system bus 613 represents one or more of several possible types of bus structures, including a memory bus or memory controller, a peripheral bus, an accelerated graphics port, or local bus using any of a variety of bus architectures. Such architectures may be an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The system bus 613, and all buses specified in this description may also be implemented over a wired or wireless network connection and each of the subsystems, including the one or more processors 603, a mass storage device 604, an operating system 605, notification software 606, notification data 607, a network adapter 608, the system memory 612, an Input/Output Interface 610, a display adapter 609, a display device 611, and a human machine interface 602, may be contained within one or more remote computing devices 614a,b,c at physically separate locations, connected through buses of this form, in effect implementing a fully distributed system.

The computer 601 typically has a variety of computer readable media. A readable media may be any available media that is accessible by the computer 601 and consists of, for example and not meant to be limiting, both volatile and non-volatile media, removable and non-removable media. The system memory 612 may be computer readable media in the form of volatile memory, such as random access memory (RAM), and/or non-volatile memory, such as read only memory (ROM). The system memory 612 typically stores data such as the notification data 607 and/or program modules such as the operating system 605 and the notification software 606 that are immediately accessible to and/or are presently operated on by the one or more processors 603.

The computer 601 may also consist of other removable/non-removable, volatile/non-volatile computer storage media. FIG. 6 shows the mass storage device 604 which may provide non-volatile storage of computer code, computer readable instructions, data structures, program modules, and other data for the computer 601. For example, and not meant to be limiting, the mass storage device 604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 604, including by way of example, the operating system 605 and the notification software 606. Each of the operating system 605 and the notification software 606 (or some combination thereof) may consist of elements of the programming and the notification software 606. The notification data 607 may also be stored on the mass storage device 604. The notification data 607 may be stored in any of one or more databases known in the art. Examples of such databases are DB2®, Microsoft® Access, Microsoft® SQL Server, Oracle®, mySQL, PostgreSQL, and the like. The databases may be centralized or distributed across multiple systems.

The user may enter commands and information into the computer 601 via an input device (not shown). Examples of such input devices may be, but are not limited to, a keyboard, pointing device (e.g., a “mouse”), a microphone, a joystick, a scanner, tactile input devices such as gloves, and other body coverings, and the like. These and other input devices may be connected to the one or more processors 603 via the human machine interface 602 that is coupled to the system bus 613, but may be connected by other interface and bus structures, such as a parallel port, game port, an IEEE 1394 Port (also known as a Firewire port), a serial port, or a universal serial bus (USB).

The display device 611 may also be connected to the system bus 613 via an interface, such as the display adapter 609. It is contemplated that the computer 601 may have more than one display adapter 609 and the computer 601 may have more than one display device 611. The display device 611 may be a monitor, an LCD (Liquid Crystal Display), or a projector. In addition to the display device 611, other output peripheral devices may consist of components such as speakers (not shown) and a printer (not shown) which may be connected to the computer 601 via the Input/Output Interface 610. Any step and/or result of the methods may be output in any form to an output device. Such output may be any form of visual representation, including, but not limited to, textual, graphical, animation, audio, tactile, and the like. The display device 611 and computer 601 may be part of one device, or separate devices.

The computer 601 may operate in a networked environment using logical connections to one or more remote computing devices 614a,b,c. A remote computing device may be a personal computer, portable computer, smartphone, a server, a router, a network computer, a peer device or other common network node, and so on. Logical connections between the computer 601 and a remote computing device 614a,b,c may be made via a network 615, such as a local area network (LAN) and/or a general wide area network (WAN). Such network connections may be through the network adapter 608. The network adapter 608 may be implemented in both wired and wireless environments. Such networking environments are conventional and commonplace in dwellings, offices, enterprise-wide computer networks, intranets, and the Internet.

For ease of explanation, application programs and other executable program components such as the operating system 605 are shown herein as discrete blocks, although it is recognized that such programs and components reside at various times in different storage components of the computing device 601, and are executed by the one or more processors 603 of the computer. An implementation of the notification software 606 may be stored on or sent across some form of computer readable media. Any of the described methods may be performed by computer readable instructions embodied on computer readable media. Computer readable media may be any available media that may be accessed by a computer. By way of example, and not meant to be limiting, computer readable media may be “computer storage media” and “communications media.” “Computer storage media” may be volatile and non-volatile, removable and non-removable media implemented in any methods or technology for storage of information such as computer readable instructions, data structures, program modules, or other data. An example of computer storage media may be, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with specific examples, it is not intended that the scope be limited to the particular examples set forth, as the examples herein are intended in all respects to be possible examples rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of examples described in the specification.

It will be apparent to those skilled in the art that various modifications and variations may be made without departing from the scope or spirit. Other examples will be apparent to those skilled in the art from consideration of the specification and practice described herein. It is intended that the specification and examples be considered as exemplary only, with a true scope and spirit being indicated by the following claims.

1. A method comprising:
determining that a first computing device is causing output of content;
determining,
a start of an advertisement portion of the content, wherein the advertisement portion comprises a plurality of sections, and
an end time for each section of the plurality of sections; and
sending, to a second computing device at a time prior to the end time for each section of the plurality of sections, a content notification that indicates an entity that sponsored the notification and a time remaining in the advertisement portion.

2. The method of claim 1, further comprising determining that an account associated with the second computing device is configured for content notifications.

3. The method of claim 1, further comprising determining that the second computing device is located within a household associated with a user of the second computing device.

4. The method of claim 1, further comprising sending, at a time prior to a start of a content portion, a portion notification.

5. The method of claim 1, further comprising receiving a request for content notifications, wherein the request comprises a device identifier.

6. The method of claim 1, further comprising determining, from a plurality of entities, the entity as a primary entity for the advertisement portion.

7. The method of claim 6, wherein the primary entity is determined based on a user preference.

8. A method comprising:
determining that a first computing device is causing output of content;
determining,
a start of an advertisement portion of the content, and
an end time of the advertisement portion;
determining, from a plurality of entities, a primary entity; and
sending, to a second computing device at a time prior to the end time, a content notification that indicates the primary entity sponsored the notification, wherein the content notification indicates a time remaining in the advertisement portion.

9. The method of claim 8, further comprising determining that an account associated with the second computing device is configured for content notifications.

10. The method of claim 8, further comprising determining that the second computing device is located within a household associated with a user of the second computing device.

11. The method of claim 8, further comprising sending, at a time prior to a start of a content portion, a portion notification.

12. The method of claim 8, further comprising receiving a request for content notifications, wherein the request comprises a device identifier.

13. The method of claim 8, wherein the advertisement portion comprises a plurality of section, the method further comprising sending, at a time prior to an end time for each section of the plurality of sections, the content notification, wherein the content notification indicates the primary entity and a time remaining in each section of the plurality of sections.

14. The method of claim 8, wherein the primary entity is determined based on a user preference.

15. A method comprising:
determining that a first computing device is causing output of content;
determining a user preference;
determining, based on the user preference and from a plurality of entities, an entity;
determining,
a start of an advertisement portion of the content, and
an end time of the advertisement portion; and
sending, to a second computing device at a time prior to the end time, a content notification that indicates the entity sponsored the notification and a time remaining in the advertisement portion.

16. The method of claim 15, further comprising determining that an account associated with the second computing device is configured for content notifications.

17. The method of claim 15, further comprising determining that the second computing device is located within a household associated with a user of the second computing device.

18. The method of claim 15, further comprising receiving a request for content notifications, wherein the request comprises a device identifier.

19. The method of claim 15, wherein the advertisement portion comprises a plurality of sections, the method further comprising sending, at a time prior to an end time for each section of the plurality of sections, the content notification, wherein the content notification indicates the entity and a time remaining in each section of the plurality of sections.

20. The method of claim 15, wherein the entity is a primary entity determined from a plurality of entities.
